(19) United States
(12) Patent Application Publication
(10) Pub. No.: US 2010/0051393 A1
(43) Pub. Date: Mar. 4, 2010

(54) BRAKE PAD CLIP WITH INTEGRATED PAD RETURN SPRING AND WEAR INDICATOR

(75) Inventor: Tadashi Arioka, Farmington Hills, MI (US)

Correspondence Address: YOUNG BASILE, 3001 WEST BIG BEAVER ROAD, SUITE 624, TROY, MI, 48084, US

(73) Assignee: NISSAN TECHNICAL CENTER NORTH AMERICA, INC., Farmington Hills, MI (US)

(21) Appl. No.: 12/201,626

(22) Filed: Aug. 29, 2008

(51) Int. Cl. F16D 55/22; B60W 10/18

(52) U.S. Cl. 188/72.3; 192/221

(57) ABSTRACT

A brake pad assembly for use with a disc brake for a wheel of a vehicle, the disc brake having a caliper and a rotor, is disclosed herein. First and second brake pads are positioned on opposing sides of the rotor and configured to engage the rotor when urged together by the caliper. Each of the first and second brake pads includes a rotor-engaging pad element and a mounting plate having a rotor facing surface. A first clip is coupled to each of the brake pads and includes a first biasing mechanism configured to urge the first brake pad away from the rotor. The first biasing mechanism has a flange positioned to engage the rotor-facing surface of the mounting plate of the first brake pad. A wear indicator extends from the flange toward the rotor.

### FIELD OF THE INVENTION

The present invention relates to the field of vehicle disc brakes, and more particularly to brake pad clips.

### BACKGROUND

Many automotive vehicles are equipped with disc brakes. A common type of disc brake includes two pad clips, two V-shaped return springs, and one or more wear indicators. The disc brake also includes two brake pads positioned on opposing sides of a rotor and urged into contact with the rotor during braking by actuation of a caliper. The pad clips each guide the movement of the brake pads. Each return spring is coupled to both brake pads, and the return springs are compressed during caliper actuation due to inward movement of the brake pads toward the rotor. After the conclusion of caliper actuation, the compressed return springs urge the brake pads outward from the rotor to end braking. Each wear indicator can be attached to one of the brake pads for movement with the brake pad when the caliper is actuated, and each wear indicator includes a tip extending toward the rotor. When the brake pad becomes sufficiently abraded, the tip of the wear indicator contacts the rotor during braking to produce a noise, thereby indicating brake pad replacement is required.

### SUMMARY

In one disclosed example, a brake pad assembly for use with a disc brake for a wheel of a vehicle is described. The disc brake has a caliper and a rotor. The brake pad assembly includes first and second brake pads positioned on opposing sides of the rotor and configured to engage the rotor when urged together by the caliper. Each of the first and second brake pads includes a rotor-engaging pad element and a mounting plate having a rotor-facing surface. The assembly also includes a first clip coupled to each of the brake pads. The first clip includes a first biasing mechanism configured to urge the first brake pad away from the rotor. The first biasing mechanism has a flange positioned to engage the rotor-facing surface of the mounting plate of the first brake pad. A wear indicator extends from the flange toward the rotor.

In another example, a disc brake assembly for a wheel of a vehicle is described. The disc brake includes a caliper connected to the vehicle and a rotor connected to the wheel. First and second brake pads are positioned on opposing sides of the rotor and configured to engage the rotor when urged together by the caliper. Each of the first and second brake pads includes a rotor-engaging pad element and a mounting plate having a rotor-facing surface. A first clip is coupled to each of the brake pads and includes a first biasing mechanism configured to urge the first brake pad away from the rotor, with the first biasing mechanism having a flange positioned to engage the rotor-facing surface of the mounting plate of the first brake pad. A wear indicator extends from the flange toward the rotor.

In yet another example, a method for installing a pair of brake pads, each brake pad having a rotor-engaging pad element and a mounting plate with a rotor-facing surface, on a disc brake for a wheel of a vehicle is described. The disc brake has a caliper and a rotor. The method includes providing a clip having a first biasing mechanism with a flange and a wear indicator extending from the flange. The method additionally includes slidably engaging first and second brake pads with the clip to contact the rotor-facing surface of the first brake pad with the flange of the first biasing mechanism such that the first biasing mechanism urges the first brake pad away from the rotor and the wear indicator on the flange of the first biasing mechanisms extends toward the rotor.

### BRIEF DESCRIPTION OF THE DRAWINGS

The description herein makes reference to the accompanying drawings wherein like reference numerals refer to like parts throughout the several views, and wherein:

FIG. 1 is a partial side view of a vehicle including a disc brake;

FIG. 2 is an exploded view of an example of a disc brake according to the present invention;

FIG. 3 is a partial perspective view of a pad clip and two brake pads engaged with a rotor;

FIG. 4 is a perspective view of an example of a pad clip according to the present invention;

FIG. 5 is a partial top view of the pad clip of FIG. 4 and two brake pads engaged with a rotor;

FIG. 6 is a schematic of non-abraded brake pads engaged with a rotor;

FIG. 7 is a schematic of the non-abraded brake pads of FIG. 6 disengaged from the rotor;

FIG. 8 is a schematic of abraded brake pads engaged with a rotor;

FIG. 9 is a perspective view of another example of a pad clip according to the present invention;

FIG. 10 is a partial top view of the pad clip of FIG. 9 and two brake pads engaged with a rotor.

### DETAILED DESCRIPTION

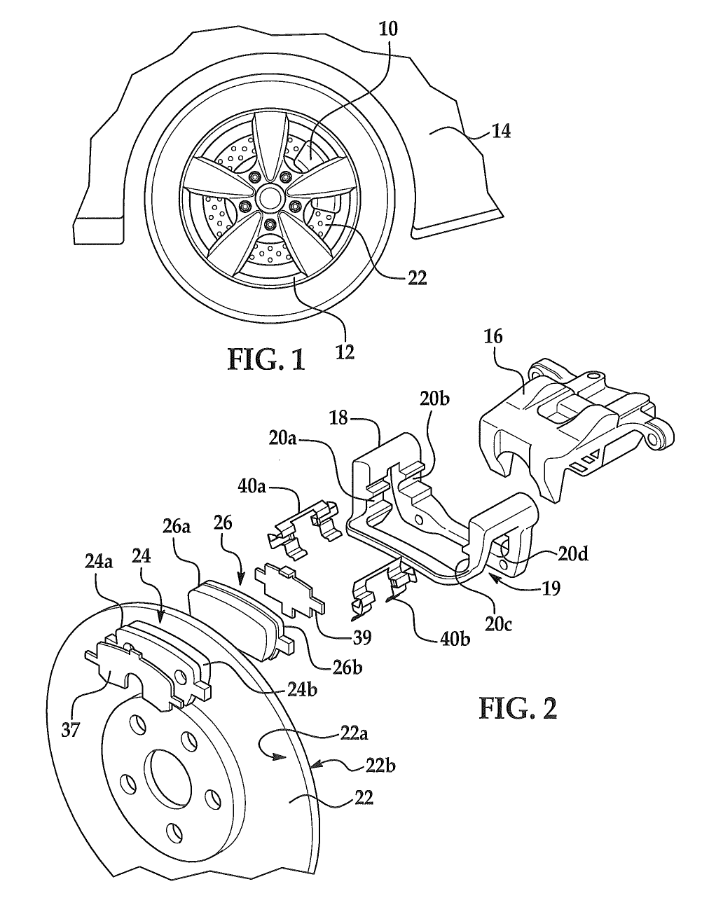

FIGS. 1-10 illustrate examples of a brake pad assembly according to the present invention. FIG. 1 illustrates a disc brake 10 attached to a vehicle 14 in a position overlaying a portion of a rotor 22 coupled to a wheel 12 of the vehicle 14. As shown in FIG. 2, the disc brake 10 includes a caliper 16, a support 18, a first brake pad 24, a second brake pad 26, a first pad clip 40a, and a second pad clip 40b. The disc brake 10 can also include shims 37 and 39 and other parts not illustrated.

The rotor 22 can be generally disc shaped and can include structures such as apertures designed to dissipate heat generated as a result of friction between the rotor 22 and brake pads 24 and 26. The rotor 22 can be made from a metal, such as cast-iron, or another material, such as reinforced carbon fiber. The rotor 22 defines a first side 22a and a second side 22b opposing the first side 22a. Due to the coupling between the wheel 12 and rotor 22, the rotor 22 rotates with the wheel 12. The coupling between the wheel 12 and rotor 22 can be accomplished by, for example, bolting the rotor 22 to the wheel 12.

The support 18 defines a channel 19 illustrated in FIG. 2. A portion of the rotor 22 passes through the channel 19 when the disc brake 10 is attached to the vehicle 14 in the position illustrated in FIG. 1. The support 18 also defines brake pad tracks 20a-d as shown in FIG. 2. With the disc brake 10 positioned such that a portion of the rotor 22 passes through the channel 19, two of the tracks 20a and 20c are on the first axial side 22a of the rotor 22 and the other two tracks 20b and 20d are on the second axial side 22b of the rotor 22.

The caliper 16 as shown in FIG. 2 can be connected to the support 18 using, for example, bolts. The caliper 16 can be in communication with a brake pedal of the vehicle 14 for actuation of the caliper 16. For example, the caliper 16 can be hydraulically, pneumatically, or electronically controlled in response to actuation of the brake pedal. The caliper 16 can also be in communication with the brake pads 24 and 26 to urge the brake pads toward the rotor 22 as is described below in greater detail.

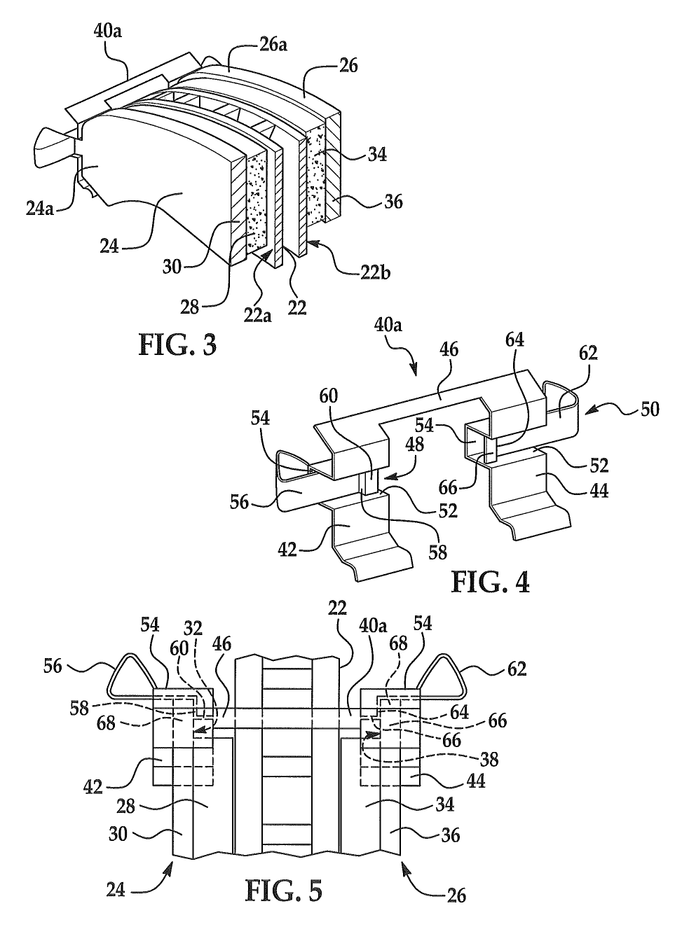

When the disc brake 10 as shown in FIG. 2 is assembled, the pad clip 40a (also referred to as “the clip 40a”) can be positioned over the tracks 20a and 20b and the pad clip 40b can be positioned over the tracks 20c and 20d such that the pad clips 40a and 40b guide the brake pads 24 and 26 during movement of the brake pads 24 and 26 relative to the tracks 20a-d. That is, when the brake pads 24 and 26 are installed, as shown in FIG. 3, the first pad clip 40a slidably receives both the first end 24a of the first brake pad 24 and the first end 26a of the second brake pad 26, with the brake pads 24 and 26 on opposing sides 22a and 22b, respectively, of the rotor 22.

The first brake pad 24 can include a pad element 28 facing the first side 22a of the rotor 22 and a mounting plate 30 bonded to the pad element 28. Alternatively, the mounting plate 30 and pad element 28 can be connected with another structure, such as a pair of bolts. Similarly, the second brake pad 26 can include a pad element 34 facing the second side 22b of the rotor 22 and a mounting plate 36 bonded to the pad element 34. The pad elements 28 and 34 can be made of a friction generating material with good heat dissipation properties such as a material including aramid fibers, while the mounting plates 30 and 36 can be made of a rigid material such as steel. Other materials can be used for the pad elements 28 and 34 and the mounting plates 30 and 36 as understood by one of skill in the art.

As shown in FIG. 4, the first pad clip 40a can include a first leg 42 and a second leg 44. A bridge 46 can connect the first and second legs 42 and 44, and the bridge 46 can be angled relative to the legs 42 and 44 to follow the contour of the support 18. The leg 42 can define a first brake pad guide 48, and the second leg 44 can define a second brake pad guide 50. The brake pad guides 48 and 50 can be contoured to the tracks 20a and 20c, respectively. For example, greater than one guide 48 or 50 can be included on each leg 42 and 44. As shown in FIG. 4, the first brake pad guides 48 and 50 each include a groove 52 having a base 54 offset from, but generally parallel to, the remainder of its leg 42 or 44. Ends of the legs 42 and 44 opposite the bridge 46 can be also be angled to follow the contours of the support 18. The pad clips 40a and 40b can have an alternative geometry from the clip 40a shown in FIG. 4, depending on the geometry of the support 18 and other components of the disc brake 10. As examples, the legs 42 and 44 and bridge 46 can have curved shapes, the bridge 46 may extend in a different direction, and the guides 48 and 50 can be shaped differently. Additionally, while each pad clip 40a and 40b as shown is designed to be positioned with its legs 42 and 44 engaging two of the tracks 20a-d, the pad clip 40a can be designed to be positioned over one or more than two tracks 20a-d. For example, pad clips 40a and 40b can be formed as one integral pad designed to be positioned over all the tracks 20a-d. The pad clips 40a and 40b can be formed of from a sheet of metal, e.g., steel, or formed from another material using another process, e.g., a molded composite.

Still referring to FIG. 4, first and second biasing mechanisms 56 and 62 can be formed integrally with the pad clip 40a. Proximal ends of the biasing mechanisms 56 and 62 loop outward from the pad clip 40a before extending inward through the respective grooves 52 as shown in FIG. 4. The looped shape of the biasing mechanisms 56 and 62 lends the mechanisms 56 and 62 a resilient characteristic such that when deformed from the geometries as shown in FIG. 4, the biasing mechanisms 56 and 62 produce a force to rebound back to their original geometries. The geometries of the biasing mechanisms 56 and 62 can be different from illustrated in FIG. 4, though the mechanisms 56 and 62 should retain a degree of resiliency.

The biasing mechanism 56 can includes a flange 58 at its distal end and a wear indicator 60 extending from the flange 58, while the biasing mechanism 62 can similarly include a flange 64 at its distal end and a wear indicator 66 extending from the flange 64. The biasing mechanism 56, flange 58, and wear indicator 60 can be formed integrally, as can the biasing mechanism 62, the flange 64, and the wear indicator 66. However, the biasing mechanisms 56 and 62 can alternatively be separate pieces from at least one of the respective flanges 58 and 64 and wear indicators 60 and 66. The flanges 58 and 64 can be generally perpendicular to the legs 42 and 44, respectively, though the exact orientation of the flanges 5 8 and 64 can be different from illustrated and can change during braking due to resilient deformation of the pad clip 40a. The wear indicators 60 and 66 can each be angled at approximately right angles relative to the flanges 58 and 64, respectively, though the angle of the wear indicators 60 and 66 can vary depending on the geometry of the pad clip 40a and can vary when the biasing mechanisms 56 and 62 are deformed from the illustrated geometries.

As shown in FIG. 5, the pad clip 40a can be positioned with the legs 42 and 44 on opposing sides 22a and 22b, respectively, of the rotor 22 such that the bridge 46 spans the rotor 22. Each mounting plate 30 and 36 forms an integral tab 68. The tabs 68 can be shaped to conform to the brake guides 48 and 50 of the pad clips 40a and 40b for movement along the tracks 20a-d defined by the support. The tab 68 of the mounting plate 30 defines part of a first rotor facing surface 32, while the tab 68 of the mounting plate 36 defines part of a second rotor facing surface 38. Each of the tabs 68 is slidably engaged with one of the guides 48 and 50 such that the rotor facing surface 32 of the first mounting plate 30 contacts the first flange 58 and the rotor facing surface 38 of the second mounting plate 36 contacts the second flange 64. Alternatively, the tabs can have a different shape from the illustrated tabs 68, and fewer or more tabs 68 can be included than illustrated.

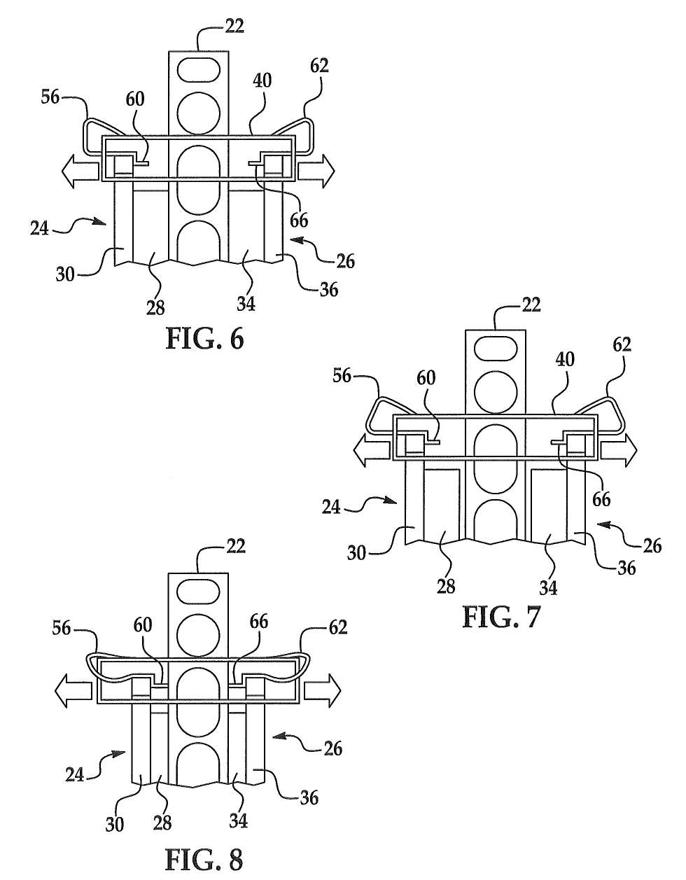

FIGS. 6 and 7 show the pad clip 40a and brake pads 24 and 26 during braking and shortly after braking, respectively. As shown in FIG. 6, the brake pads 24 and 26 are subject to an inward force (for example, a force produced by the caliper 16) causing the pad elements 28 and 34, respectively, to contact the rotor 22. As a result, the biasing mechanisms 56 and 62 are deformed from their normal positions and energized to produce outward forces on the mounting plates 30 and 36, respectively, represented by the arrows in FIG. 6. Friction is generated between the rotor 22 and the pads 24 and 26, thereby slowing the rotational speed of the rotor 22. As the rotor 22 slows, the rotational speed of the wheel 12 also slows due to the coupling between the wheel 12 and rotor 22. As the rotational speed of the wheel 12 slows, the speed of the vehicle 14 decreases. Thus, actuation of the disc brake 10 can slow the speed of the vehicle 14. Also, with the non-abraded pad elements 28 and 34 of FIG. 6, the wear indicators 60 and 66 in FIG. 6 are spaced from the rotor 22 even though the brakes 24 and 26 are in an engaged position.

In FIG. 7, the brake pads 24 and 26 are no longer subject to the inward force. Thus, the biasing mechanisms 56 and 62 can urge the brake pads 24 and 26 away from the rotor 22. Once the biasing mechanisms 56 and 62 move the pads 28 and 34, respectively, such that the pads 28 and 34 are not in contact with the rotor 22, braking stops.

The pad elements 28 and 34 are abraded in FIG. 8. Pad element abrasion occurs because each time the brakes 24 and 26 are engaged, the friction between the pad elements 28 and 34 and the rotor 22 wears away at the pad elements 28 and 34. Over time, the abrasion can become significant enough that braking performance diminishes. When the pad elements 28 and 34 are worn to a predetermined level as illustrated in FIG. 8, the pad elements 28 and 34 are sufficiently thin so that the wear indicators 60 and 66 contact the rotor 22 during braking. As a result of contact with the rotor 22, the wear indicators 60 and 66 can produce an audible indication that the pad elements 28 and 34 are worn and in need of replacement.

FIGS. 3-8 are described with reference to the first pad clip 40a; however, the second pad clip 40b can have the same geometry as the first pad clip 40a and thus the description of FIGS. 3-8 can be equally applicable to the second pad clip 40b, though the pad clip 40b can be rotated 180 degrees relative to the pad clip 40a when installed.

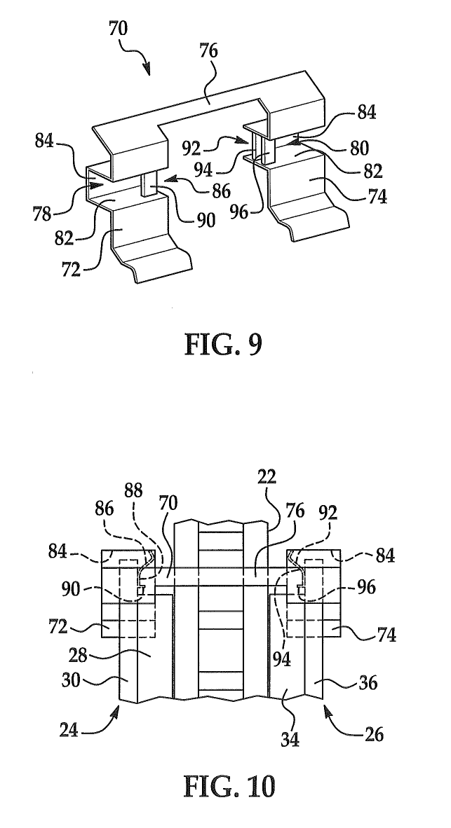

FIGS. 9 and 10 illustrate another example of a pad clip 70. The pad clip 70 can include a first leg 72 and a second leg 74. A bridge 76 can connect the first and second legs 72 and 74, and the bridge 76 can be angled relative to the legs 72 and 74 to follow the contour of the support 18. The leg 72 can define a first brake pad guide 78, and the second leg 74 can define a second brake pad guide 80. The brake pad guides 78 and 80 can be contoured to the tracks 20a and 20c, respectively. As shown in FIG. 9, the first brake pad guides 78 and 80 each include a groove 82 having a base 84 offset from, but generally parallel to, the remainder of its leg 72 or 74. Ends of the legs 72 and 74 opposite the bridge 76 can be also be angled to follow the contours of the support 18. The pad clip 70 can have an alternative geometry from the clip 70 shown in FIG. 9, depending on the geometry of the support 18 and other components of the disc brake 10.

Still referring to FIGS. 9 and 10, first and second biasing mechanisms 86 and 92 can be formed integrally with the pad clip 70. Proximal ends of the biasing mechanisms 86 and 92 are connected to the inward sides of the bases 84 of each groove 82, and the biasing mechanisms extend from the bases 84 toward the respective legs 72 and 74. The biasing mechanisms 86 and 92 can have a curved shape to avoid high stress points during deformation. The shape of the biasing mechanisms 86 and 92 lends the mechanisms 86 and 92 a resilient characteristic such that when deformed from the geometries as shown in FIG. 9, the biasing mechanisms 86 and 92 produce a force to spring back to their original geometries.

The biasing mechanism 86 includes a flange 88 at its distal end and a wear indicator 90 extending from the flange 88, while the biasing mechanism 92 similarly includes a flange 94 at its distal end and a wear indicator 96 extending from the flange 94. The biasing mechanism 86, flange 88, and wear indicator 90 can be formed integrally, as can the biasing mechanism 92, the flange 94, and the wear indicator 96. The flanges 88 and 94 can be generally perpendicular to the legs 72 and 74, respectively, though the exact orientation of the flanges 88 and 94 can change during braking due to resilient deformation of the pad clip 70. The wear indicators 90 and 96 can each be angled at approximately right angles relative to the flanges 88 and 94, respectively, though the angle of the wear indicators 90 and 96 can vary depending on the geometry of the pad clip 70, such as when the biasing mechanisms 86 and 89 are deformed from the illustrated geometries.

The disc brake 10 as described above has several advantages. Known disc brakes can include a large number of parts. For example, a common known disc brake includes two pad clips, two return springs, and one or more wear indicators. However, each pad clip 40a and 40b can include integral biasing mechanisms 56 and 62 and wear indicators 60 and 66, and thus the disc brake 10 can use two parts instead of the five or more parts sometimes used with the known disc brake. Thus, disc brakes 10 can be less expensive to manufacture, assemble, and repair than known disc brakes.

Further, some return springs of the known disc brake apply a force to a top portion of the brake pads. Thus, the return springs may produce a moment while urging the brake pads away from the rotor. A lower radial portion of each brake pad therefore may continue to engage the rotor for some time after an upper radial portion of the brake pad disengages the rotor, potentially resulting in uneven wear of the brake pads in the known disc brake. The biasing mechanisms 56 and 62 of the pad clips 40a and 40b can apply a force axially outward from the rotor 22 without producing a moment on the brake pads 24 and 26, allowing for more even wear of the brake pads 24 and 26 than brake pads in some known disc brakes.

While the invention has been described in connection with what is presently considered to be the most practical embodiment, it is to be understood that the invention is not to be limited to the disclosed embodiments but, on the contrary, is intended to cover various modifications and equivalent arrangements included within the spirit and scope of the appended claims, which scope is to be accorded the broadest interpretation so as to encompass all such modifications and equivalent structures as is permitted under the law.

What is claimed is:

1. A brake pad assembly for use with a disc brake for a wheel of a vehicle, the disc brake having a caliper and a rotor, comprising:
first and second brake pads positioned on opposing sides of the rotor and configured to engage the rotor when urged together by the caliper, each of the first and second brake pads including a rotor-engaging pad element and a mounting plate having a rotor-facing surface; and
a first clip coupled to each of the brake pads and including a first biasing mechanism configured to urge to the first brake pad away from the rotor, the first biasing mechanism having a flange positioned to engage the rotor-facing surface of the mounting plate of the first brake pad, and a wear indicator extending from the flange toward the rotor.

2. The brake pad assembly of claim 1, wherein the wear indicator is sized and configured to contact the rotor when the first brake pad is abraded to a predetermined level and the caliper urges the first brake pad to engage the rotor.

3. The brake pad assembly of claim 1, wherein the first clip further comprises a second biasing mechanism configured to urge the second brake pad away from the rotor, second biasing mechanism having a flange positioned to engage the rotor-facing surface of the mounting plate of the second brake pad, and a wear indicator extending from the flange toward the rotor.

4. The brake pad assembly of claim 3, wherein the first clip further comprises:
a first leg;
a second leg spaced from the first leg by at least a thickness of the rotor; and
a bridge connecting the first and second legs; and
wherein the first biasing mechanism is integral with the first leg and the second biasing mechanism is integral with the second leg.

5. The brake pad assembly of claim 4, wherein the first leg defines a first brake pad guide;
wherein the mounting plate of the first brake pad is slidably engaged with the first brake pad guide; and
wherein the first biasing mechanism extends from the first brake pad guide.

6. The brake pad assembly of claim 5, wherein the second leg defines a second brake pad guide;
wherein the mounting plate of the second brake pad is slidably engaged with the second brake pad guide; and
wherein the second biasing mechanism extends from the second brake pad guide.

7. The brake pad assembly of claim 5, wherein the first brake pad guide includes a groove and the mounting plate of the first brake pad includes a tab slidably engaged with the groove; and
wherein the first biasing mechanism extends from a bed of the groove.

8. The brake pad assembly of claim 1, further comprising a second clip coupled to each of the brake pads and including a third biasing mechanism configured to urge to the first brake pad away from the rotor, the third biasing mechanism having a flange positioned to engage the rotor-facing surface of the mounting plate of the first brake pad, and a wear indicator extending from the flange toward the rotor; and
a fourth biasing mechanism configured to urge the second brake pad away from the rotor, the fourth biasing mechanism having a flange positioned to engage the rotor-facing surface of the mounting plate of the second brake pad, and a wear indicator extending from the flange toward the rotor.

9. The brake pad assembly of claim 5, wherein each of the first and second brake pads has a forward end and a rearward end; and
wherein the first clip is coupled to near the forward ends of each of the first and second brake pads, and the second clip is coupled to near the rearward ends of each of the first and second brake pads.

10. A disc brake assembly for a wheel of a vehicle, comprising:
a caliper connected to the vehicle;
a rotor connected to the wheel;
first and second brake pads positioned on opposing sides of the rotor and configured to engage the rotor when urged together by the caliper, each of the first and second brake pads including a rotor-engaging pad element and a mounting plate having a rotor-facing surface; and
a first clip coupled to each of the brake pads and including a first biasing mechanism configured to urge the first brake pad away from the rotor, the first biasing mechanism having a flange positioned to engage the rotor-facing surface of the mounting plate of the first brake pad, and a wear indicator extending from the flange toward the rotor.

11. The brake pad assembly of claim 10, wherein the wear indicator is sized and configured to contact the rotor when the first brake pad is abraded to a predetermined level and caliper urges the first brake pad to engage the rotor.

12. The brake pad assembly of claim 10, wherein the first clip further comprises a second biasing mechanism configured to urge the second brake pad away from the rotor, second biasing mechanism having a flange positioned to engage the rotor-facing surface of the mounting plate of the second brake pad, and a wear indicator extending from the flange toward the rotor.

13. The brake pad assembly of claim 12, wherein the first clip further comprises:
a first leg;
a second leg spaced from the first leg by at least a thickness of the rotor; and
a bridge connecting the first and second legs; and
wherein the first biasing mechanism is integral with the first leg and the second biasing mechanism is integral with the second leg.

14. The brake pad assembly of claim 13, wherein the first leg defines a first brake pad guide;
wherein the mounting plate of the first brake pad is slidably engaged with the first brake pad guide; and
wherein the first biasing mechanism extends from the first brake pad guide.

15. The brake pad assembly of claim 14, wherein the second leg defines a second brake pad guide;
wherein the mounting plate of the second brake pad is slidably engaged with second the brake pad guide; and
wherein the second biasing mechanism extends from the second brake pad guide.

16. The brake pad assembly of claim 14, wherein the first brake pad guide includes a groove and the mounting plate of the first brake pad includes a tab slidably engaged with the groove; and
wherein the first biasing mechanism extends from a bed of the groove.

17. The brake pad assembly of claim 10, further comprising a second clip coupled to each of the brake pads and including a third biasing mechanism configured to urge to the first brake pad away from the rotor, the third biasing mechanism having a flange positioned to engage the rotor-facing surface of the mounting plate of the first brake pad, and a wear indicator extending from the flange toward the rotor; and
a fourth biasing mechanism configured to urge the second brake pad away from the rotor, the fourth biasing mechanism having a flange positioned to engage the rotor-facing surface of the mounting plate of the second brake pad, and a wear indicator extending from the flange toward the rotor.

18. The brake pad assembly of claim 17, wherein each of the first and second brake pads has a forward end and a rearward end, and the first clip is coupled to near the forward ends of each of the first and second brake pads, and the second clip is coupled to near the rearward ends of each of the first and second brake pads.

19. A method for installing a pair of brake pads, each brake pad having a rotor-engaging pad element and a mounting plate with a rotor-facing surface, on a disc brake for a wheel of a vehicle, the disc brake having a caliper and a rotor, the method comprising:
providing a clip having a first biasing mechanism with a flange and a wear indicator extending from the flange; and
slidably engaging first and second brake pads with the clip to contact the rotor-facing surface of the first brake pad with the flange of the first biasing mechanism such that the first biasing mechanism urges the first brake pad away from the rotor and the wear indicator on the flange of the first biasing mechanisms extends toward the rotor.

20. The method of claim 19, wherein providing the clip includes providing a clip having the first biasing mechanism and a second biasing mechanism, the second biasing mechanism having a flange and a wear indicator extending from the flange; and
wherein slidably engaging the first and second brake pads includes contacting the rotor-facing surface of the second brake pad with the flange of the second biasing mechanism such that the second biasing mechanism urges the second brake pad away from the rotor and the wear indicator on the flange of the second biasing mechanisms extends toward the rotor.
